(19) United States
(12) Patent Application Publication
(10) Pub. No.: US 2005/0285496 A1
(43) Pub. Date: Dec. 29, 2005

(54) Mount for a discharge lamp

(75) Inventor: Hans Eisemann, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/159,127

(22) Filed: Jun. 23, 2005

(30) Foreign Application Priority Data
Jun. 23, 2004 (DE) 202004009859.8

(51) Int. Cl. H01J 19/50; H01J 5/48; H01J 5/50; H01J 1/00

(52) U.S. Cl. 313/238; 313/285; 313/318.01

(57) ABSTRACT

The mount is equipped with a lamp stand from which a first and second power supply line protrude such that they are parallel to one another, a first, short bracket being fixed to the first power supply line, and a second, long bracket, referred to below as a fixing bracket, being fixed to the second power supply line. The two brackets are arranged on a common plane, the two brackets being bent outwards away from the associated power supply line, and the two brackets being fixed to the associated power supply line of the stand such that they are offset with respect to one another.

### TECHNICAL FIELD

The invention relates to a mount for a discharge lamp having a lamp stand from which a first and second power supply line protrude such that they are parallel to one another, a first, short bracket being fixed to the first power supply line, and a second, long bracket, referred to below as a fixing bracket, being fixed to the second power supply line. Of particular concern here is a mount for metal halide lamps and such lamps having outer bulbs.

### BACKGROUND ART

In the case of discharge lamps having outer bulbs, a mount is required for the purpose of fixing the burner in the outer bulb.

A typical mount for halogen metal vapor lamps is shown in FIG. 3. As shown, one end of a first bracket 36 near to the stand 31 is welded to the first power supply line 38, and the other end of the bracket 36 is welded to the electrode system of the burner 32. A fixing bracket 35 is welded to the second power supply line 39 in the vicinity of the stand 31 and at the same height as the first bracket 36. In addition, the burner is fixed by a burner holder 33.

A similar mount design is described in the patent disclosure U.S. 2003184231, according to which the two power supply lines are also bent back through 45° and welded twice to the brackets.

These mount designs are suitable for evacuated outer bulbs. If the outer bulb contains a gas filling, it has been shown that discharges can form in the outer bulb, to be precise:
in the vicinity of the stand 31 between the bracket 36 and the fixing bracket 35 (path a);
at the end near to the burner between the bracket 36 and the fixing bracket 35 (path b);
between the end, which is near to the stand, of the power supply line 8 of the burner and the burner holder 33 (path c)

Furthermore, the mount design shown in FIG. 3 and in accordance with U.S. 2003184231 can only be used for halogen metal vapor lamps which do not contain sodium, since the fixing bracket is not shielded. If the burner vessel contains a sodium-containing filling, the fixing bracket 35 needs to be shielded in the vicinity of the burner vessel or needs to be guided past it at a considerable spacing. Otherwise, the lamps have a much shortened life owing to Na diffusion.

A typical form of shielding for the fixing bracket is specified, for example, in the patent U.S. Pat. No. 6,356,016. With this mount design, outer bulb discharges are prevented since no brackets are welded in the vicinity of the stand, the burner holder is dispensed with, and the shielding reaches down far beyond the fixing bracket in the direction of the stand. However, the manufacture of such a mount requires a different, complex machine design compared to the mount illustrated in FIG. 3.

The patent U.S. Pat. No. 6,326,721 describes a mount which compensates for, in particular, the thermal expansion of the burner during lamp operation. This mount is also unsuitable for outer bulb gas fillings, since spacings between the mount wires which are too narrow bring about outer bulb discharges and destruction of the lamp.

U.S. Pat. No. 6,118,216 describes a metal halide lamp, in which direct contact is made between the burner of said metal halide lamp at one end and a bent-back power supply line. Contact is made between the other end of the burner and the second power supply line by means of a leadwire which is guided past the burner at a considerable distance from it. The leadwire and the bent-back electrode lie on two parallel planes transverse with respect to the lamp stand. This lamp design is suitable for outer bulb gas fillings and also for Na-containing burner fillings, since the spacings between the current-carrying parts and between said current-carrying parts and the burner are selected to be sufficiently large. The discharge lamp in accordance with U.S. Pat. No. 6,118,216, however, dispenses with a mount and is therefore only suitable for low-wattage lamps having powers of ≦150 W and for small, lightweight burners. Since the leadwire is not shielded, the lamp construction in the case of Na-containing fillings is restricted only to elliptical outer bulbs.

### DISCLOSURE OF THE INVENTION

It is the object of the present invention to provide a mount for a discharge lamp having a lamp stand from which a first and second power supply line protrude such that they are parallel to one another, a first, short bracket being fixed to the first power supply line, and a second, long bracket, referred to below as a fixing bracket, being fixed to the second power supply line, which mount has a small tendency to flashover.

A further object is to achieve a high degree of robustness using as few mount parts as possible, and to specify a mount which is particularly well suited to a gas filling in the outer bulb, but is of course also suitable for lamps without a gas filling in the outer bulb, and which can be manufactured without substantially changing existing machines. The mount according to the invention can be used for lamps having any desired power ratings. A further object is to specify an associated discharge lamp which achieves a long life of typically 20 000 hours, it also being possible for Na-containing fillings to be used.

This object is achieved by the following features: the two brackets are arranged on a common plane, the two brackets being bent outwards away from the associated power supply line, and the two brackets being fixed to the associated power supply line in each case at a point of contact such that they are offset with respect to one another.

Particularly advantageous refinements are described in the dependent claims.

In accordance with the invention, a mount design is selected in the case of which the brackets are welded to the power supply lines such that they are offset in the vicinity of the stand. In particular, the burner holder is dispensed with. In order to lock in place the burner sufficiently well without the use of a burner holder, the bracket is preferably manufactured from steel wire having a metallic coating, in particular nickel-plated steel wire.

The lamp according to the invention has an inner bulb, in particular a discharge vessel, which is sealed in a vacuum-tight manner, defines a lamp axis and is sealed at mutually opposing ends.

The inner bulb is accommodated in an outer bulb which is sealed at one end and which is preferably provided with an inert filling, which preferably contains nitrogen, carbon dioxide and a noble gas, in each case alone or in combination.

In detail, the mount has a lamp stand from which a first and second power supply line protrude such that they are parallel to one another, a first, short bracket being fixed to the first power supply line, and a second, long bracket, often referred to below as a fixing bracket, being fixed to the second power supply line, the two brackets being arranged on a common plane, the two brackets being bent outwards away from the associated power supply line, and the two brackets being fixed to the associated power supply lines of the stand such that they are offset with respect to one another.

The preferred form of fixing consists in the brackets and the power supply line being welded to one another. However, other types of fixing, such as soldering, are not ruled out.

In order to reliably ensure a sufficient spacing and avoidance of flashovers, the diagonal spacing between the weld spots should be at least 6 mm. In detail, it is prescribed by the geometry of the other lamp components.

In this case, the length of the power supply lines is of no importance. A first embodiment is configured such that the two power supply lines of the stand are of equal length. A second embodiment is configured such that the lengths of the two power supply lines of the stand are different. A typical difference in the free lengths outside the lamp stand is 50 to 130%.

In order to sufficiently lock in place the burner without the use of a burner holder, the material preferably used for the first bracket is steel wire having a metallic coating, whose diameter is, in particular, the same as that of the fixing bracket and possibly of any holding wire provided. In particular, a suitable material for the bracket is nickel-plated steel wire, its diameter being equal to that of the fixing bracket and holding wire, said fixing bracket and holding wire being made from nickel-plated iron. The holding wire serves the purpose of fixing that end of the burner which faces away from the stand to the mount.

As an alternative, however, in particular the first bracket may have a greater diameter than the fixing bracket and possibly the holding wire, it being possible for all of these parts to be made from the same material.

The bracket diameter is advantageously 1.5 to 2.5 mm, whereas the diameters of the fixing bracket and the holding wire are 75 to 95% of the bracket diameter, in particular all of the parts being made from nickel-plated iron.

The discharge lamps according to the invention typically have a metal halide filling, for example iodides of the rare earths and/or the alkali or alkaline earth group, such as mercury and noble gas. This filling is enclosed in the discharge vessel or burner in a vacuum-tight manner. Furthermore, the burner is typically sealed at two ends and surrounded by an outer bulb which is sealed at one end.

Such lamps have until now been particularly susceptible to flashovers given a relatively high filling pressure in the outer bulb, in particular if the outer bulb contains an inert filling gas having a cold filling pressure of at least 300 mbar. This new design for the mount now reliably eliminates this risk. It is therefore now possible, in particular, for nitrogen or nitrogen/neon mixtures having a pressure of at least 400 mbar to be contained in the outer bulb, which until now has not been possible. The same applies to the case in which the outer bulb contains carbon dioxide or a carbon dioxide/neon mixture having a pressure of at least 300 mbar.

However, it is of course also possible to use the mount according to the invention at lower filling pressures, in particular if the outer bulb has been evacuated.

### BRIEF DESCRIPTION OF THE DRAWINGS

The invention will be explained in more detail below with reference to a plurality of exemplary embodiments. In the drawings:

FIG. 1 shows a side view of an exemplary embodiment of a mount;

FIG. 2 shows a side view of a further exemplary embodiment of a complete lamp; and

FIG. 3 shows a mount in accordance with the prior art.

### BEST MODE FOR CARRYING OUT THE INVENTION

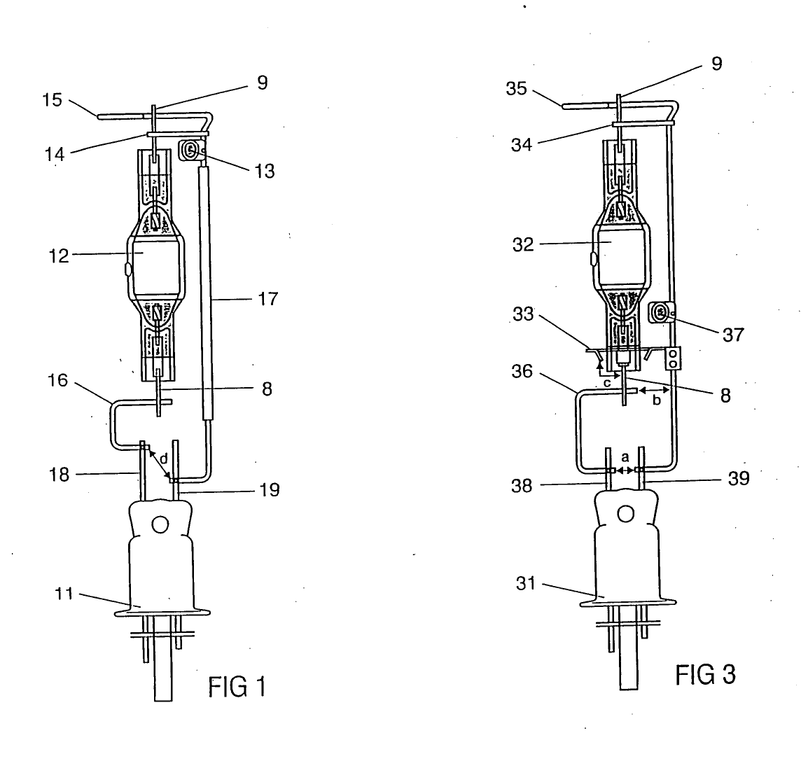

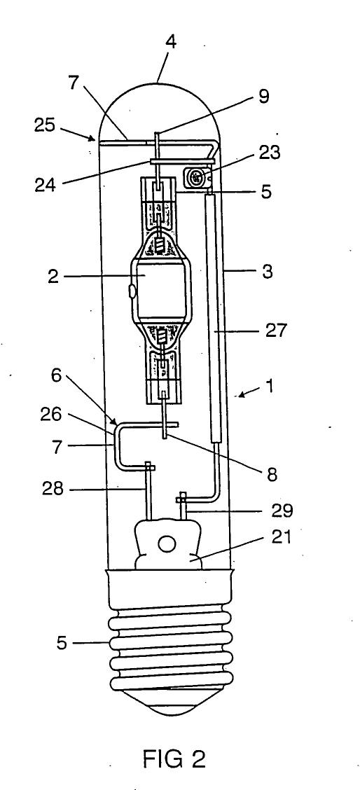

One exemplary embodiment of the mount for a metal halide lamp having a power of 250 W is illustrated in FIG. 1. A stand 11 made from hard glass surrounds two straight, outer power supply lines 18, 19 which lie parallel with respect to one another on one plane. According to FIG. 1, a first end of a first U-shaped bracket 16 near to the stand 11 is welded to the first power supply line 18, and the other end of the first bracket 16 is welded to the power supply line 8, which is near to the base, of the electrode system of the burner 12. A fixing bracket 15 is welded to the second power supply line 19 in the vicinity of the stand 11. The end of the fixing bracket 15 which is remote from the stand is bent in the form of a circle in order to fix the burner 12 axially symmetrically in the outer bulb (cf. FIG. 2). Contact is made between a holding wire 14 and the power supply line 9, which is remote from the base, of the electrode system of that end of the burner 12 which is remote from the stand and the fixing bracket 15 in order to ensure current flow. A getter 13 is fitted to that end of the fixing bracket which is remote from the stand. The fixing bracket 15 is shielded along the length of the burner 12 using a ceramic tube 17 in order to achieve a long lamp life even with sodium-containing burner fillings. The length of the ceramic tube is selected such that the fixing bracket 15 not only shields the burner 12 but also is extended beyond the weld spot between the power supply line 12 which is near to the base and the bracket 16 in order to prevent an outer bulb discharge.

The essence of the invention consists in the bracket 16 and the fixing bracket 15 which are fixed, in particular welded, to the power supply lines 18 and 19 such that they are offset. In this case, the diagonal spacing d between the weld spots is selected such that, typically, 8 mm is maintained, but 6 mm is not undershot. The diagonal spacing between the weld spots may also be selected to be greater than 8 mm and can be fixed depending on the geometry of the other lamp components. A typical upper limit for d is 10 mm.

In order to sufficiently lock in place the burner without the use of a burner holder, it is proposed that nickel-plated steel wire is used as the material for the bracket 16, its diameter being equal to that of the fixing bracket 15 and holding wire 14 if said fixing bracket 15 and holding wire 14 are made from nickel-plated iron. In the exemplary embodiment shown in FIG. 1, the diameters of the bracket 16, the fixing bracket 15 and the holding wire 14 are in each case 1.75 mm. The bracket 16 is manufactured with a larger diameter of typically 2 mm if it is also made from nickel-plated iron.

The use of steel wire having a metallic coating, in particular coated with nickel, for one or more of the mount parts, in particular the first bracket and possibly the fixing bracket, is particularly advantageous in conjunction with the diagonally offset weld spots. However, even when it is used on its own it likewise has an inventive effect since it is thus possible to dispense with a burner holder which entails the risk of flashovers. A thin wire, in particular having a small diameter of up to 1.8 mm (typical lower limit is 1.5 mm), has a high degree of rigidity and tensile strength, but can bend more easily than a thicker wire. It is therefore clearly superior to the materials which have often been used to date, such as nickel-plated iron.

A second exemplary embodiment of the invention is specified in FIG. 2 with the entire lamp. The reference numerals for the same parts are 10 higher than in FIG. 1. In contrast to FIG. 1, the outer power supply lines 28, 29, which are fixed in the stand 21, have different lengths in FIG. 2. The diagonal spacing between the weld spots is similar to as specified in relation to FIG. 1. A 250 W metal halide lamp 1 is illustrated schematically as the lamp in FIG. 2. It comprises a discharge vessel 2 made from quartz glass, which is pinched at two ends and is surrounded by a cylindrical, evacuated or else gas-filled outer bulb 3 made from hard glass, which has a base at one end. The material selected for the discharge vessel 2 may also be ceramic. One end of the outer bulb 3 has a rounded-off dome 4, whereas the other end has a screw base 5. A holding mount 6 fixes the discharge vessel 2 axially in the interior of the outer bulb 3. The holding mount 6 comprises two brackets 25, 26, of which one bracket 26 is connected to the power supply line 8, which is near to the base, of the discharge vessel 2. The other fixing bracket 25 is passed via a solid holding wire 24 to the power supply line 9 which is remote from the base. It also has a support 7 in the vicinity of the dome 4 in the form of a partial circle. The volume of the discharge vessel 2 is approximately 5.2 ml. The carrier gas in the discharge vessel is 56 mbar of Ar. In order to reduce the flashover voltage, a Penning mixture with 90 mbar of Ne:Ar=99.65:0.35 may alternatively be used as the carrier gas.

The discharge vessel 2 is preferably operated within an outer bulb 3, which has been evacuated for particularly good color rendering. If the burner contains the abovementioned Penning mixture, an outer bulb gas mixture having 600 mbar of N₂—Ne or 450 mbar of CO₂—Ne is used to lengthen the life.

The outer bulb filling gas of the lamp shown in, for example, FIG. 1, typically comprises nitrogen and neon in a ratio of the volume percentages of N₂:Ne=46:54 and a pressure of 600 mbar. However, the specific filling gas is irrelevant. It is merely important that it is inert and comprises mixtures which contain nitrogen, carbon dioxide CO₂ and/or noble gas, preferably argon or neon. The mount design shown in FIGS. 1 and 2 can be used, in particular, at an outer bulb gas pressure of greater than or equal to 400 mbar of nitrogen or a nitrogen/neon mixture and greater than or equal to 300 mbar of carbon dioxide or a carbon dioxide/neon mixture. The upper pressure limit needs to be below the bursting pressure of the outer bulb (depending on the material and geometry). A typical upper limit is a few bar.

For example, a metal halide filling is used which comprises halides of Na, Tl and In, also in combination with Sn.

A second example of a metal halide filling is the use of V and Mn halides. These may advantageously be combined with or replaced by further halides, for example of the elements Cs, Dy, Tl, Ho, Tm and Na.

The two fillings make it possible to achieve a life of 20 000 hours.

1. A mount for a discharge lamp having a lamp stand from which a first and second power supply line protrude such that they are parallel to one another, a first, short bracket being fixed to the first power supply line, and a second, long bracket, referred to below as a fixing bracket, being fixed to the second power supply line, wherein the two brackets are arranged on a common plane, the two brackets being bent outwards away from the associated power supply line, and the two brackets being fixed to the associated power supply line in each case at a point of contact such that they are offset with respect to one another.

2. The mount as claimed in claim 1, wherein the brackets and the power supply line are each welded to one another.

3. The mount as claimed in claim 2, wherein the diagonal spacing d between the points of contact, in particular weld spots, is at least 6 mm.

4. The mount as claimed in claim 1, wherein the two power supply lines of the stand are of equal length.

5. The mount as claimed in claim 1, wherein the lengths of the two power supply lines of the stand are different.

6. The mount as claimed in claim 1, wherein the material used for the first bracket is steel wire having a metallic coating, whose diameter is, in particular, the same as that of the fixing bracket and possibly of any holding wire provided.

7. The mount as claimed in claim 6, wherein the material used for the first bracket is nickel-plated steel wire, its diameter being equal to that of the fixing bracket and possibly of any holding wire provided, the fixing bracket and possibly the holding wire being made from nickel-plated iron.

8. The mount as claimed in claim 1, wherein the bracket has a larger diameter than the fixing bracket and possibly a holding wire, all of these parts being made from the same material.

9. The mount as claimed in claim 8, wherein the bracket diameter is 1.5 to 2.5 mm, whereas the diameters of the fixing bracket and the holding wire are 75 to 95% of the bracket diameter, in particular all of the parts being made from nickel-plated iron.

10. A mount for a discharge lamp having a lamp stand from which a first and second power supply line protrude such that they are parallel to one another, a first, short bracket being fixed to the first power supply line, and a second, long bracket, referred to below as a fixing bracket, being fixed to the second power supply line, wherein at least the first, short bracket is manufactured from steel wire having a metallic coating, in particular nickel being used as the metal.

11. The mount as claimed in claim 10, wherein at least the first, short bracket is manufactured from steel wire having a metallic coating and having a diameter of a maximum of 1.8 mm.

12. The mount as claimed in claim 10, wherein the fixing bracket is also made from a coated steel wire.

13. A discharge lamp having the mount as claimed in claim 1, the discharge lamp having a burner which is sealed at two ends and an outer bulb which is sealed at one end.

14. The discharge lamp as claimed in claim 13, wherein the outer bulb contains an inert filling gas having a cold filling pressure of at least 300 mbar.

15. The discharge lamp as claimed in claim 14, wherein the outer bulb contains nitrogen or a nitrogen/neon mixture having a pressure of at least 400 mbar.

16. The discharge lamp as claimed in claim 14, wherein the outer bulb contains carbon dioxide or a carbon dioxide/neon mixture having a pressure of at least 300 mbar.

17. The discharge lamp as claimed in claim 13, wherein the outer bulb has been evacuated.

18. The discharge lamp as claimed in claim 13, wherein the fixing bracket is surrounded by a sleeve at the height of the burner, and this sleeve reaches beyond the point of contact between the first bracket and the power supply line, which is near to the base, of the burner.

19. A discharge lamp having the mount as claimed in claim 10, the discharge lamp having a burner which is sealed at two ends and an outer bulb which is sealed at one end.
